(19) United States
(12) Patent Application Publication
(10) Pub. No.: US 2026/0201809 A1
(43) Pub. Date: Jul. 16, 2026

(54) TURBINE COMPONENT LEAKAGE AIR CIRCUITS

(71) Applicant: RTX CORPORATION, Farmington, CT (US)

(72) Inventors: Howard J. LILES, Newington, CT (US); Winston SMIDDY, South Windsor, CT (US)

(73) Assignee: RTX CORPORATION, Farmington, CT (US)

(21) Appl. No.: 19/025,319

(22) Filed: Jan. 16, 2025

(51) Int. Cl. F01D 5/18; F01D 11/08; F01D 25/12; F02C 7/18; F23R 3/00

(52) U.S. Cl. CPC F01D 11/08; F01D 11/24; F05D 2220/32

(57) ABSTRACT

A gas turbine engine component, comprising a first surface having at least one first aperture, and exposed to a first plenum comprising a mixed fluid flow and a first pressure; at least one second surface having at least one second aperture, and exposed to a gas path fluid flow and at least one second pressure; at least one channel, at least one internal plenum or both at least one channel and at least one internal plenum disposed between and in fluid communication with each the at least one first aperture and the at least second aperture.

### FIELD OF THE INVENTION

The subject matter disclosed herein relates to turbine component leakage air and, in particular, to a circuit for redirecting turbine component leakage air.

### BACKGROUND OF THE INVENTION

Gas turbine engine components experience challenges providing adequate cooling to intersegment, e.g., mate-face, gaps between their respective shrouds and/or platforms. These components, and respective intersegments, may include blades; BOAS, also known as shrouds; and, vanes. The challenge to provide adequate cooling is sometime remedied by providing dedicated cooling channels that exit into the mate-face gap to provide purge and/or impingement cooling. However, purge and/or impingement cooling comes at a performance cost by increasing the turbine cooling leakage air (“TCLA”) utilized by the gas turbine engine component. In addition, when ceramic matrix composite (“CMC”) components are utilized, large thermal gradients may form from very cold cooling air mixing with hot gas path air that may cause undesirable thermal stresses experienced by the gas turbine engine components.

Consequently, there exists a need to cool these intersegment gaps while mitigating the performance impact discussed above.

### SUMMARY OF THE INVENTION

The present disclosure is directed, in a first aspect, to a gas turbine engine component, comprising a first surface having at least one first aperture, and exposed to a first plenum comprising a mixed fluid flow and a first pressure; at least one second surface having at least one second aperture, and exposed to a gas path fluid flow and at least one second pressure; at least one channel, at least one internal plenum or both at least one channel and at least one internal plenum disposed between and in fluid communication with each the at least one first aperture and the at least second aperture.

In further embodiments of the present disclosure, including further embodiments of the above exemplary embodiments, the at least one aperture comprises a structural mixing feature.

In further embodiments of the present disclosure, including further embodiments of the above exemplary embodiments, the structural mixing feature comprises a structural feature capable of mixing the mixed fluid flow and the gas path fluid flow.

In further embodiments of the present disclosure, including further embodiments of the above exemplary embodiments, wherein the at least one second pressure comprises a second pressure, a third pressure and a fourth pressure.

In further embodiments of the present disclosure, including further embodiments of the above exemplary embodiments, the first pressure is greater than or approximately equal to the second pressure.

In further embodiments of the present disclosure, including further embodiments of the above exemplary embodiments, the third pressure is greater than the fourth pressure.

In further embodiments of the present disclosure, including further embodiments of the above exemplary embodiments, one or more of the at least one first aperture, the at least one second aperture, the at least one channel or the at least one internal plenum comprise one or more of the following cross-sectional shapes: geometrical, non-geometrical, circular, non-circular, and combinations thereof.

In further embodiments of the present disclosure, including further embodiments of the above exemplary embodiments, the at least one first aperture is proximate to a leading edge of the gas turbine engine component.

In further embodiments of the present disclosure, including further embodiments of the above exemplary embodiments, the at least one second aperture comprises at least one of the following surface locations: gas path oriented, intersegment, trailing edge, and combinations thereof.

In further embodiments of the present disclosure, including further embodiments of the above exemplary embodiments, the gas turbine engine component comprises at least one of the following: a blade outer air seal, a blade, a vane, combustor liners, exhaust nozzles, and combinations thereof.

In further embodiments of the present disclosure, including further embodiments of the above exemplary embodiments, the mixed fluid flow comprises a mixture of the gas path fluid flow having a first temperature and a leakage fluid flow having a second temperature, wherein the mixed fluid flow comprises a third temperature.

In another embodiment, the present disclosure is directed to a gas turbine engine component, comprising a first surface having at least one first aperture comprising a structural mixing feature, and exposed to a first plenum comprising a mixed fluid flow path and a first pressure; at least one second surface having at least one second aperture, and exposed to a gas path fluid flow and at least one second pressure; at least one channel, at least one internal plenum or both at least one channel and at least one internal plenum disposed between and in fluid communication with each the at least one first aperture and the at least second aperture.

In further embodiments of the present disclosure, including further embodiments of the above exemplary embodiments, the structural mixing feature comprises a structural feature capable of mixing the mixed fluid flow and the gas path fluid flow.

In further embodiments of the present disclosure, including further embodiments of the above exemplary embodiments, the at least one second pressure comprises a second pressure, a third pressure and a fourth pressure.

In further embodiments of the present disclosure, including further embodiments of the above exemplary embodiments, the first pressure is greater than or approximately equal to the second pressure.

In further embodiments of the present disclosure, including further embodiments of the above exemplary embodiments, the third pressure is greater than the fourth pressure.

In further embodiments of the present disclosure, including further embodiments of the above exemplary embodiments, one or more of the at least one first aperture, the at least one second aperture, the at least one channel or the at least one internal plenum comprise one or more of the following cross-sectional shapes: geometrical, non-geometrical, circular, non-circular, and combinations thereof.

In further embodiments of the present disclosure, including further embodiments of the above exemplary embodiments, the at least one first aperture is proximate to a leading edge of the gas turbine engine component.

In further embodiments of the present disclosure, including further embodiments of the above exemplary embodiments, wherein the at least one second aperture comprises at least one of the following surface locations: gas path oriented, intersegment, trailing edge, and combinations thereof.

In further embodiments of the present disclosure, including further embodiments of the above exemplary embodiments, the gas turbine engine component comprises at least one of the following: a blade outer air seal, a blade, a vane, combustor liners, exhaust nozzles, and combinations thereof.

In further embodiments of the present disclosure, including further embodiments of the above exemplary embodiments, the mixed fluid flow comprises a mixture of the gas path fluid flow having a first temperature and a leakage fluid flow having a second temperature, wherein the mixed fluid flow comprises a third temperature.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a representative illustration, not drawn to scale, of a blade outer air seal incorporating an exemplary leakage flow circuit.

FIG. 2 is another representative illustration, not drawn to scale, of another blade outer air seal incorporating both the exemplary leakage flow circuit of FIG. 1 and a brush seal, disposed adjacent a vane platform.

FIG. 3 is yet another representative illustration, not drawn to scale, of yet another blade outer air seal incorporating the exemplary leakage flow circuit of FIG. 1 disposed adjacent a vane platform and forming a chordal seal therebetween, and disposed opposite another vane platform that also incorporates the exemplary leakage flow circuit of FIG. 1, and having a “W” seal disposed therebetween.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

The present disclosure is directed to an exemplary leakage flow circuit for use within a gas turbine engine component. The exemplary leakage flow circuit incorporates at least one intersegment channel having at a surface with a first intersegment aperture exposed to a plenum of leakage air upstream from the gas turbine engine component. The intersegment channel may connect the aforementioned plenum to a second intersegment aperture at an opposing surface of the component downstream of the plenum. From the first intersegment aperture to the second intersegment aperture, the leakage flow travelling through the channel may experience a drop in pressure and provide cooling/purge benefit as the flow exits the channel. The number, shape and size of the intersegment apertures may be adjusted for manufacturing needs and to obtain desired cooling and flow characteristics, and may be tuned so that a sufficient amount of leakage flow may still be leveraged as a leading edge film credit. Although reference is made to, e.g., a second intersegment aperture, the second aperture may be one or more apertures located at one or more of the following surface locations: gas path oriented, intersegment, trailing edge, combinations thereof, and the like.

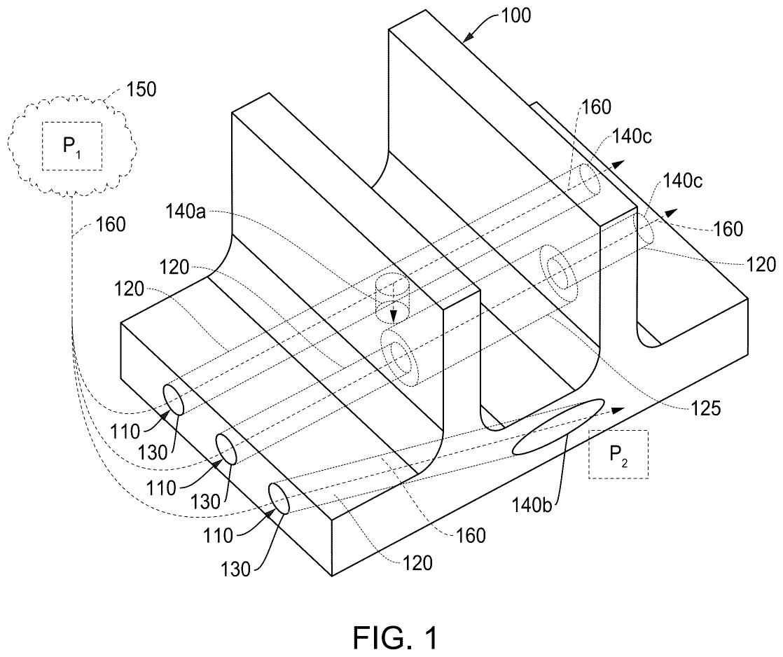

Referring now to FIG. 1, a gas turbine engine component 100, e.g., a blade outer air seal (“BOAS”), may incorporate an exemplary leakage flow circuit 110. The exemplary leakage flow circuit 110 may include at least one channel 120 at least one aperture 130, e.g., a first intersegment aperture 130, and at least one second aperture 140a,b,c, disposed at opposing ends. In at least one other embodiment, the exemplary leakage flow circuit 110 may further include at least one internal plenum 125 into which the channel 120, e.g., intersegment channel, may be in fluid communication therewith for introducing an incoming fluid flow, and at least one additional channel in fluid communication therewith for exhausting an outgoing fluid flow from the internal plenum 125. In either embodiment, the channel 120 and/or internal plenum 125 may be fabricated using any technique capable of boring such a channel and/or internal plenum through and/or within the material of the gas turbine engine component 100 without degrading the integrity of the material. The channel 120, internal plenum 125, and/or first and second apertures 130, 140a,b,c may comprise any cross-sectional shape, diameter and/or length suitable for facilitating the flow of a fluid through the gas turbine engine component 100. For example, although not shown, a fluid flow through the internal plenum 125 may swirl around throughout the enclosed area. Due to the swirling effect, the pressure of the fluid flow may be lowered further. In at least one embodiment, a suitable cross-sectional shape may include, but is not limited to, geometric, non-geometric, circular, non-circular, combinations thereof, and the like. In yet at least one other embodiment, a suitable diameter and/or length may reflect the dimensions of the gas turbine engine component. For example, in at least one embodiment, the length may extend the entire length of the gas turbine engine component or only a fraction of the entire length. In yet at least one other embodiment, a suitable diameter may be approximately 5 mil to approximately 100 mil. Next, with respect to the first apertures 130, in at least one embodiment, the first aperture 130 may comprise an aperture proximate to a leading edge of the gas turbine engine component 100. Next, with respect to the at least one second apertures 140a,b,c, in at least one embodiment, the second aperture 140a,b,c may comprise a purge or an exit aperture proximate to, e.g., a film surface, i.e., film exit aperture 140a; an intersegment surface, i.e., intersegment exit aperture 140b; or a trailing edge surface, i.e., trailing edge exit aperture 140c. The exemplary leakage flow circuit 110 may encompass any number of channels 120 whose respective apertures 140a,b,c may exit any number of surfaces of the gas turbine engine component 100.

While the flow circuit 100 refers to “leakage flow”, the flow circuit may include a mixing structural feature (not shown) that may mix a leakage flow and a gas path fluid flow from a plenum 150 located upstream from the gas turbine engine component 100 to form a mixed fluid flow entering the first aperture 130. The gas path fluid flow may exhibit and possess a first temperature reflecting its exposure to the hot gas flowing through the gas turbine engine during operation. The resultant mixed fluid flow may exhibit and possess a temperature lower than the first temperature and greater than the second temperature. In addition to the difference in temperature, the mixed fluid flow also may exhibit and possess a first pressure (P₁) reflecting its proximate location upstream. Once the mixed fluid flow travels through the channel 120 and exits the second aperture 140a,b,c, the mixed fluid flow enters an area downstream exhibiting and possessing a second pressure (P₂). Due to the difference in location, that is, upstream versus downstream, there may exist a pressure differential between P₁ and P₂ such that P₁ is greater than P₂. In at least one other embodiment, the pressure differential between P₁ and P₂ may be negligible such that P₁ and P₂ may be approximately equal to one other.

Utilizing the exemplary leakage flow circuit 110, the leakage air flowing downstream of a sealing component may be redirected into and through the circuit 110. The redirected air flow 160 instead may provide intersegment cooling to both axially oriented surfaces and circumferentially oriented surfaces. That is, as the redirected fluid flow 160 enters a forward section, the pressure drop may pull and draw the redirected fluid flow 160 to an aft section of the gas turbine engine component 100. The redirected fluid flow 160 may then purge through the second intersegment aperture 140a,b,c and cool not only the part of the gas turbine engine component containing the channel 120, but also additional gas turbine components proximate the second apertures 140a,b,c. Exemplary sealing components may include, but are not limited to, individual sealing components, sealing components comprising features of one or more different gas turbine engine components abutting with or adjacent to each other that form a seal or exhibit a sealing function, combinations thereof, and the like. Suitable individual sealing components may include, but are not limited to, “W”, omega, dog bone, diamond, brush, rope, hair pin, piston, combinations thereof, and the like. Suitable gas turbine engine components may include, but are not limited to, blade outer air seal, blade, vane, exhaust case(s) and their respective parts, exhaust nozzle and their respective parts, combustor and their respective parts, combinations thereof, and the like, that form an integral seal such as, but not limited to, chordal, face, combinations thereof, and the like.

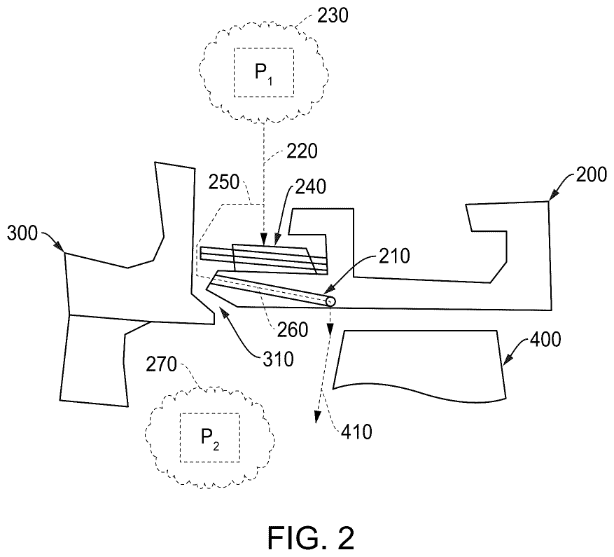

For example, referring now to FIG. 2, a first gas turbine engine component 200, e.g., a blade outer air seal, containing an exemplary leakage flow circuit 210 may be disposed adjacent a second gas turbine engine component 300, e.g., a vane, along a mate-face gap 310 formed therebetween, and above and proximate to a third gas turbine engine component 400, e.g., a blade. A fluid flow 220 from a plenum 230 may encounter a seal 240, e.g., a brush seal, disposed adjacent a surface of the gas turbine engine component 200. The seal 240 may prevent a certain amount of fluid flow 220 from entering the mate-face gap 310. However, the remaining amount, e.g., a leakage fluid flow 250, may pass the seal 240, enter the mate-face gap 310 and become redirected fluid flow 260 along a leading edge of the component 200, rather than curl into a gas path fluid flow area 270. The redirected fluid flow 260 may enter the exemplary leakage flow circuit 210 and exit in a fluid flow path 410 along a surface of the adjacent third gas turbine engine component 400. During operation, the adjacent third gas turbine engine component 400 may be in motion and may draw the exiting or purging redirected fluid flow 260 downward toward the fluid flow path 410. The exemplary leakage flow circuit 210 may leverage the leakage fluid flow downstream of the seal 240 to provide purging and cooling redirected fluid flow 260 for further downstream uses. For instance, at least a portion of the purging and cooling redirected fluid flow 260 may mix with gas path fluid flow in the area 270 and provide “warmer” cooling fluid flow along the intersegment gaps and gas path surfaces of component 200 or a component positioned aft to component 200.

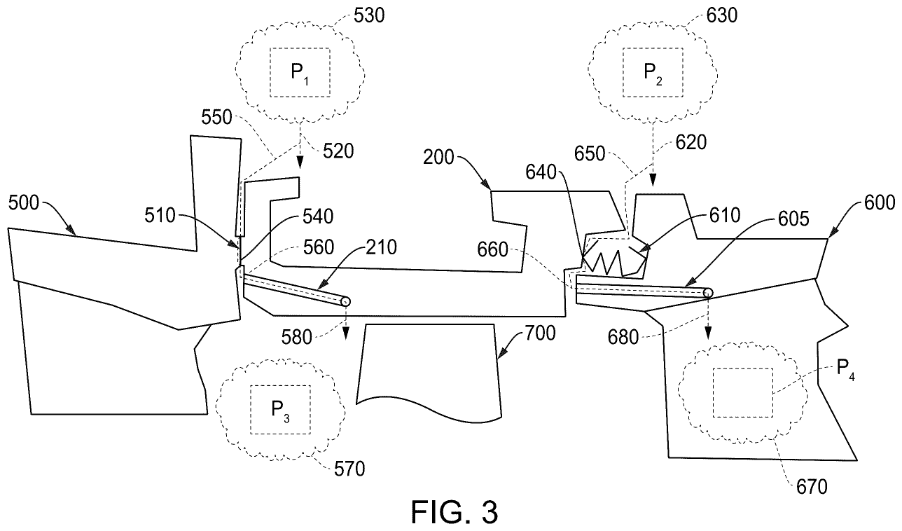

In yet another example, referring now to FIG. 3, a first gas turbine engine component 200, e.g., a blade outer air seal, containing an exemplary leakage flow circuit 210 may be disposed between a fourth gas turbine engine component 500, e.g., a vane, and a fifth gas turbine engine component 600, e.g., another vane, and above and proximate to a sixth gas turbine engine component 700, e.g., a blade, that also includes an exemplary leakage flow circuit 605. The first gas turbine engine component 200 and fourth gas turbine engine component 500 adjacent one another may form a chordal seal 510, that is, a mate-face seal that forms at the juncture of two sealing surfaces of two adjacent components. The first gas turbine engine component 200 and fifth gas turbine engine component 600 adjacent one another, and opposite the fourth gas turbine engine component 500, may have a seal 610, e.g., a “W” seal, disposed therebetween. At least one fluid flow 520, 620 from at least one plenum 530, 630 having a first pressure P₁ and/or a second pressure P₂ may encounter the chordal seal 510 and “W” seal 610, respectively. In at least one embodiment, the respective plenums of the first and second pressures P₁ and P₂ may be separated by an additional seal (not shown) or an additional component (not shown) and instead may be in fluid communication via another separate channel (not shown). For these reasons, the first pressure P₁ may be approximately equal to or greater than the second pressure P₂. Just as described above, the seals 510, 610 may prevent a certain amount of fluid flow 520, 620 from entering a mate-face gap 540, 640. However, the remaining amount, e.g., a leakage fluid flow 550, 650, may pass either one or both seals 510, 610, enter the mate-face gap 540, 640 and become redirected fluid flow 560, 660 along a leading edge of the first gas turbine engine component 200 and fifth gas turbine engine component 600, respectively, rather than curl into a gas path fluid flow area 570, 670 having a respective third and fourth pressures P₃ and/or P₄ respectively. In at least one embodiment, while the first pressure P₁ may be approximately equal to the second pressure P₂, the third pressure P₃ is greater than the fourth pressure P₄ so that the gas turbine (not shown) rotates during operation. The redirected fluid flows 560, 660 may enter the exemplary leakage flow circuits 210, 605 and exit in a fluid flow path 580, 680 along a surface of the adjacent sixth gas turbine engine component 700 and a surface of the fifth gas turbine engine component 600, respectively. During operation, the adjacent fifth gas turbine engine component 600 may be in motion and may draw the exiting or purging redirected fluid flow 660 downward toward the fluid flow path 680. The exemplary leakage flow circuits 210, 605 may leverage the leakage fluid flow downstream of the respective seals 540, 640 to provide purging and cooling redirected fluid flows 560, 660 for further downstream uses. For instance, at least a portion of the purging and cooling redirected fluid flows 560, 660 may mix with gas path fluid flows in the areas 570, 670 and provide “warmer” cooling fluid flow to adjacent ceramic matrix composite based gas turbine engine components while not driving excessively large thermal gradients.

The exemplary leakage fluid flow circuit disclosed herein may be incorporated into a variety of gas turbine engine components possessing intersegment or mate-face gaps that may benefit from additional cooling and/or may benefit from exposure to a fluid flow exhibiting and possessing a moderate thermal gradient. The exemplary leakage fluid flow circuit disclosed herein utilizes leakage fluid flow, i.e., air, that may have already traveled past a seal and redirects said leakage fluid flow. Without the exemplary circuit disclosed herein, the leakage fluid flow would not be redirected, but rather simply enter a gas path and/or gas path area. In turn, the gas turbine engine component, and surrounding adjacent components, would require a dedicated cooling fluid flow during operation. In contrast, incorporating the exemplary leakage fluid flow circuit increases the efficiency of the gas turbine engine component containing the circuit as well as other surrounding, adjacent gas turbine engine components also exposed to the redirected fluid flow.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

1. A gas turbine engine component, comprising:
a first surface having at least two first apertures, and exposed to at least one plenum comprising a mixed fluid flow and a first pressure;
at least one second surface having at least one second aperture, and exposed to a gas path fluid flow and at least one second pressure;
at least one channel, at least one internal plenum or both at least one channel and at least one internal plenum disposed between and in fluid communication with each of the at least two first apertures and the at least one second aperture.

2. (canceled)

3. (canceled)

4. The gas turbine engine component of claim 1, wherein the at least one second pressure comprises a second pressure, a third pressure and a fourth pressure.

5. The gas turbine engine component of claim 4, wherein the first pressure is greater than or approximately equal to the second pressure.

6. The gas turbine engine component of claim 4, wherein the third pressure is greater than the fourth pressure.

7. The gas turbine engine component of claim 1, wherein one or more of the at least two first apertures, the at least one second aperture, the at least one channel or the at least one internal plenum comprise one or more of the following cross-sectional shapes: geometric, non-geometric, circular, non-circular, and combinations thereof.

8. The gas turbine engine component of claim 1, wherein the at least two first apertures are proximate to a leading edge of the gas turbine engine component.

9. The gas turbine engine component of claim 1, wherein the at least one second aperture comprises at least one of the following surface locations: gas path oriented, intersegment, trailing edge, and combinations thereof.

10. The gas turbine engine component of claim 1, wherein the gas turbine engine component comprises at least one of the following: a blade outer air seal, a blade, a vane, combustor liners, exhaust nozzles, and combinations thereof.

11. The gas turbine engine component of claim 1, wherein the mixed fluid flow comprises a mixture of the gas path fluid flow having a first temperature and a leakage fluid flow having a second temperature, wherein the mixed fluid flow comprises a third temperature.

12. A gas turbine engine component, comprising:
a first surface having at least two first apertures, and exposed to at least two internal plenums comprising a mixed fluid flow path and a first pressure;
at least one second surface having at least one second aperture, and exposed to a gas path fluid flow and at least one second pressure;
at least one channel, at least two internal plenums or both at least one channel and at least two internal plenums disposed between and in fluid communication with each of the at least two first apertures and the at least one second aperture.

13. (canceled)

14. The gas turbine engine component of claim 12, wherein the at least one second pressure comprises a second pressure, a third pressure and a fourth pressure.

15. The gas turbine engine component of claim 14, wherein the first pressure is greater than or approximately equal to the second pressure.

16. The gas turbine engine component of claim 14, wherein the third pressure is greater than the fourth pressure.

17. The gas turbine engine component of claim 12, wherein one or more of the at least two first apertures, the at least one second aperture, the at least one channel or the at least two internal plenums comprise one or more of the following cross-sectional shapes: geometric, non-geometric, circular, non-circular, and combinations thereof.

18. The gas turbine engine component of claim 12, wherein the at least two first apertures are proximate to a leading edge of the gas turbine engine component.

19. The gas turbine engine component of claim 12, wherein the at least one second aperture comprises at least one of the following surface locations: gas path oriented, intersegment, trailing edge, and combinations thereof.

20. The gas turbine engine component of claim 12, wherein the gas turbine engine component comprises at least one of the following: a blade outer air seal, a blade, a vane, combustor liners, exhaust nozzles, and combinations thereof.

21. The gas turbine engine component of claim 12, wherein the mixed fluid flow comprises a mixture of the gas path fluid flow having a first temperature and a leakage fluid flow having a second temperature, wherein the mixed fluid flow comprises a third temperature.
